(19) United States
(12) Patent Application Publication
(10) Pub. No.: US 2026/0051085 A1
(43) Pub. Date: Feb. 19, 2026

(54) Method for generating a dataset for training and/or testing a machine learning system

(71) Applicants: ROBERT BOSCH GmbH, Stuttgart (DE); CARIAD SE, Wolfsburg (DE)

(72) Inventors: Julio Borges, Stuttgart (DE); Kevin Alexander Laube, Rottenburg Am Neckar (DE)

(21) Appl. No.: 19/297,858

(22) Filed: Aug. 12, 2025

(30) Foreign Application Priority Data
Aug. 16, 2024 (EP) 24195032.8

(51) Int. Cl. G06T 11/00; G06N 3/0475

(52) U.S. Cl. CPC G06T 11/00; G06N 3/0475

(57) ABSTRACT

The invention relates to a method (100) for generating at least one data set for training and/or testing a machine learning system (55), the generation being provided by a control model (50).

### RELATED APPLICATION

This application claims the benefit of European patent application EP24195032.8 (filed, Aug. 16, 2024), the entirety of which is incorporated by reference herein.

### FIELD OF THE INVENTION

The invention relates to a method for generating at least one data set. The invention further relates to a machine learning model, a computer program, a device, and a memory medium for this purpose.

### BACKGROUND

Image synthesis by generative artificial intelligence (AI) refers to the generation of images using generative models that are trained to generate visual content. Certain conditions or inputs may be specified. Thus, the model may respond, for example, to various input forms, from simple text descriptions all the way to complex data sets.

Image synthesis allows a wide range of applications, in particular also for training and/or testing a machine learning system for driver assistance systems or autonomous driving. The flexible, adaptable application of conditions and inputs is of particular importance.

It is known from the prior art that existing methods for image synthesis are primarily based on a limited number of conditions. With technologies such as ControlNet, it is possible to control the generation of synthetic images, using Stable Diffusion, via conditional inputs that go beyond simple text inputs. These conditions may be derived from actual images as well as from simulated environments.

However, when multiple conditions, for example Canny edge, depth map, or semantic label map, are used, problems such as degradation of image synthesis quality may arise with these approaches. For this reason, the combination of multiple conditions, in particular for various image regions, still represents a challenge.

### SUMMARY

The subject matter of the invention involves a method having the features of claim 1, a machine learning model having the features of claim 11, a computer program having the features of claim 13, a device having the features of claim 14, and a computer-readable memory medium having the features of claim 15. Further features and details of the invention result from the respective subclaims, the description, and the drawings. Features and details that are described in conjunction with the method according to the invention naturally also apply in conjunction with the machine learning model according to the invention, the computer program according to the invention, the device according to the invention, and the computer-readable memory medium according to the invention, and vice versa in each case, so that with regard to the disclosure of the invention, reciprocal reference is always possible.

The subject matter of the invention in particular involves a method for generating at least one data set for training and/or testing a machine learning system, in particular for an application for vehicle control. The generation may be provided by an in particular generative control model which is likewise based on machine learning, and which thus may be designed as a learning system or a portion thereof.

The method according to the invention may include the training and/or testing of the control model in order to train the control model for the application of combined conditions. Alternatively or additionally, the method according to the invention may also include the inference of the control model, in which combined conditions may be selected. It is likewise possible for the method according to the invention to include use of the data set for the learning system and/or the inference of the learning system.

The method according to the invention may include selecting at least two different conditions, which are selected for an application for the generation of the data set. The conditions may each provide different control options for the generation of the data set. An influence of the particular condition on the generation may be specified. This may also be described as control of the generation, or a control influence on the generation.

Furthermore, the method according to the invention may include selecting areas within the conditions in which the application of the conditions is excluded, preferably the application of all conditions is excluded. This allows certain areas of the data set to be generated by the (selected/combined) conditions without limitation.

The conditions may be spatially defined, and thus preferably designed as at least two-dimensional conditions. This is the case, for example, when the conditions are designed as masks or maps that spatially define various specifications for the generation, so that the particular specification is used only for a certain area. Alternatively, the conditions may thus also be referred to as masks/maps or condition masks, so that the areas are correspondingly areas in the mask/map. The selected areas may be at least two-dimensional areas in the maps, and may be indicated by coordinates, for example. The spatially defined conditions may be designed as semantic segmentation label maps or Canny edges, to name a few examples.

The conditions may also be specific algorithms, filters, and/or processing rules, for example, which are defined at least two-dimensionally by at least one map and which therefore are to be applied to certain areas within the map. The conditions, for example as a specification for the generation, may provide various processing rules based on pixels, in particular the pixel values.

The areas may represent different regions or segments within the map, each of which has different properties or features. For example, in one area of a semantic segmentation label map, specific objects such as buildings or streets could be identified, while another area could contain information about vegetation or the like. In the areas that are highlighted by Canny edges, specialized filters or algorithms for edge reinforcement or for highlighting object boundaries may optionally be applied.

In addition, the method according to the invention may include combining of the selected conditions. This may be possible via a corresponding specification, for example, that is used by the control model.

According to the method according to the invention, generation of the data set by means of the control model (i.e., in particular by and/or controlled by the control model) for application of the combined conditions, and with consideration of the selected areas, may subsequently be provided. The control model may be a machine learning model such as a ControlNet diffusion model. The control model may be designed as a single control model, and in particular may have been trained (end-to-end) for application of the combined conditions. Depending on the architecture, the control model itself may be designed as a generative model, or designed to control another generative model (such as Stable Diffusion).

The method according to the invention provides a flexible option for automatically generating data sets and in particular for image synthesis, which in an automated manner allows
a) multiple conditions to be simultaneously taken into account, and/or
b) various combinations of these conditions to be used during the inference period, and/or
c) for areas to also be completely excluded from the influence of one or more of the conditions.

For applications such as autonomous driving or the like, the method according to the invention allows generation of data sets, in particular image data, that provide precise detailing of a setting, in particular a traffic scenario. At the same time, a variety of settings may be represented by taking into account only the conditions in certain spatial regions. Thus, for example, for a certain area a higher weight may be placed on Canny edges than on semantic labels to allow precise contours and shapes to be represented.

However, in other areas the weight may be reversed so that the semantic labels are more strongly emphasized. Areas may also be provided in which no conditions are applied at all, and therefore the diffusion model can carry out the synthesis without limitation.

The conditions for each setting and/or for each image may be combined, and at the same time, areas may also be partially or completely excluded from the influence of the conditions. In other words, it is possible to select the conditions and the areas for each image/setting according to the method according to the invention

It is likewise conceivable, during generation of the data set, for control of the generation process to be carried out by the control model corresponding to the selected conditions and/or limited to the nonexcluded area.

According to the method according to the invention, areas may also be selected in which the application of the conditions is completely excluded, and in which none of the conditions thus specify the influence and/or are applied, and therefore the generation, with respect to the conditions, takes place uncontrolled by use of the control model. This makes it possible for there to be areas in which (combined) multiple conditions simultaneously exercise control and/or an influence of multiple conditions is simultaneously specified, and for there also to be areas in which no control at all is exercised by the conditions.

The selection may, for example, be a masking of elements in the image via which it is determined which conditions are used for the element. In this regard, these may also be described as masking conditions. “Masking” conditions mean in particular that elements/areas for the various conditions (for example, semantic labels or label maps, Canny edges) are masked to control their influence on the image synthesis. Due to masking, the influence of a certain condition may be reduced or even eliminated, so that a control model such as ControlNet can correctly process the various conditions and control the image synthesis of the generative model in various ways, depending on the requirements of the problem in question.

To allow the control of the generation process by means of the combined conditions, it may be provided that a control model such as ControlNet is trained using joint masked conditions. It is even possible to use a training process, known per se, unchanged, by merely adding a new component that provides a joint combination of multiple conditions.

Starting from a base image, also referred to as an original image, multiple conditions may be extracted in order to train a control model such as ControlNet, for example, which learns how the image is to be reconstructed in light of the conditions. The extraction of Canny edges and a semantic label map may also be provided using a pretrained semantic segmentation model. It is likewise possible to apply human annotations if they are present. More than two or some other combination of conditions is preferably possible (for example, depth map and semantic label map, etc.).

In principle, for each type of condition (Canny, semantic labels, etc.), three possible actions via masked conditions come into consideration in the training of ControlNet: 1) full retention, 2) partial retention (according to classes or areas), or 3) removal.

During the training process, the masks which determine how the various conditions/specifications are applied may be selected according to the random principle. In this way, during the inference period the control model, in particular ControlNet, learns to rely on a single condition (only canny edge or only semantic labels, for example), a complete combination of both, or a partial combination of both. The user may thus freely decide which conditions to use, and how they would preferably be combined during the inference period.

In addition, it is advantageous when the method further comprises:
detecting a first user input that specifies a manual selection of the conditions, and/or
detecting a second user input that specifies a manual selection of the areas.

The selection of the conditions may take place based on the first user input, and/or the selection of the areas may take place based on the second user input, to allow the user to decide which conditions are to be combined, and/or to allow the user to mask those conditions that control their influence on the generation of the data set, in particular on an image synthesis. As a result, the control model can process various user inputs and outputs in order to control the combination of conditions.

Furthermore, it may be possible for the machine learning system to be designed as a model for image synthesis, preferably as an image diffusion model, and/or for the control model to be designed as a model for controlling an image diffusion model for image synthesis.

Moreover, it is conceivable for the data set to include multiple synthetic images that represent objects in an environment, which are provided for training and/or testing the machine learning system. The environment may be, for example, the surroundings of a camera and/or of a vehicle.

In addition, a configuration and/or arrangement of the objects may be influenced by the application of the conditions. This has the advantage that the machine learning system may be trained and tested based on multiple conditions, which allows greater flexibility and precision in the image generation. The combination of various conditions allows generation of high-quality images that are a function of a subset of conditions.

According to one advantageous refinement of the invention, it may be provided that the application of the combined conditions is provided by a single control model. The generation of the data set may thus take place by use of only a single control model, in particular an end-to-end trained model such as ControlNet. It may thus be provided that the combined conditions are provided by a single control model that contains all necessary information for the control and/or generation of the data set. In particular, the disadvantages resulting from a cascading application of control models having various conditions may thus be reduced.

It is optionally conceivable for the method to further comprise:
providing original images that are provided for training the control model and/or an image diffusion model that is controlled by the control model.

It is also possible for the method to comprise:
carrying out the selection of the areas in the form of pixels and/or points and/or two-dimensional areas, in particular in the original image, in which the in particular combined conditions are not to be provided, i.e., are to be excluded.

This yields the advantage that the control model can simultaneously take a plurality of conditions into account, which results in greater flexibility and precision in the image generation. In addition, precise detailing of the setting may be achieved by the combination of multiple conditions.

According to a further advantage, it may be provided that the generated images and/or the original images represent a traffic scenario in order to use the data set for training and/or testing the machine learning system for controlling a vehicle for at least semi-autonomous driving and/or for a driver assistance system. This yields the advantage that the images may be optimized by using the combined and masked conditions for training machine learning models in the area of vehicle control, since traffic scenarios typically represent very complex environments with many objects and interactions.

It is also conceivable for the training to be provided for training the machine learning system, using the generated data set, for classification, in particular image classification, of digital images based on image points and/or pixels, in particular pixel values, preferably edges or pixel attributes (of the images). These digital images may be, for example, digital images that result from a recording by at least one sensor, preferably at least one camera, preferably of a vehicle and particularly preferably of the camera surroundings and/or vehicle surroundings during travel (of a vehicle). The recording may be carried out, for example, by at least one camera of the vehicle. The classification may be provided for recognizing objects in an environment depicted by the digital images and/or for capturing a traffic scenario.

The classification may be provided for various technical applications. One example is the application in a vehicle. Based on the classification, in particular at least one classification result, for example at least one control action, preferably for a vehicle or for some other technical system, may be initiated and/or carried out.

A classification result may include at least one of the following results and/or may be specific for at least one of the following results: a category of objects, an identification of objects, a position of objects and/or obstacles (for example, in the travel direction or next to the travel direction), the presence of obstacles, a description of a traffic scenario, a hazard alert, the number of objects, a type and/or position of roadway markings and/or a roadway boundary, a position and/or a state of traffic signal installations, a position of a roadway, or the like.

Based on the classification result, at least one control action for the vehicle may be initiated and/or carried out. The control action may include at least one of the following: braking, steering, acceleration, passing, emergency braking, activation of an alarm system, activation of a hazard flasher, activation of a travel direction indicator, a light control system, or the like.

By use of the classification it is possible to recognize an obstacle, for example, regardless of whether it is situated directly in the travel direction or next to it. Depending on the location (for example, as a function of the probable vehicle trajectory), an appropriate control action such as deceleration or evasion may be initiated.

For example, braking may also be initiated when the classification indicates that obstacles are present in the travel direction and/or that a collision is likely. It is also conceivable for a roadway and/or a roadway boundary to be recognized based on the classification, in order to move the vehicle on the roadway at least semi-automatedly by means of the control action.

The vehicle may be designed as a motor vehicle and/or a passenger car and/or an at least semi-autonomous vehicle.

The “classification” and “image classification” may also encompass “object detection” or “object detection in images.” This is understood in particular as a classification of whether or not objects are present in certain areas of the image. In addition, the terms “classification” and “image classification” may also refer to “semantic segmentation,” in particular in the form of pixel-by-pixel classification.

In the invention it may advantageously be provided that, via the selection of the conditions and areas, an influence of the conditions may be dynamically retained, partially retained, and/or removed during a generation process for the data set. This has the advantage that flexible control of the image generation is made possible. Various areas may be taken into account without affecting the entire generated output of the model in the areas in question. It may thus be ensured that the control is applied to specific areas, while other areas are still able to make use of the free creative potential of the diffusion model.

It is also optionally conceivable for conditions to include at least two of the following elements and/or further similar elements:
Canny edges, in particular for edge and structure recognition,
semantic labels, in particular for classification and annotation of objects,
a color palette, in particular for visual differentiation and classification,
depth maps, in particular for capturing and analyzing spatial information.

It is thus possible for various features of the image or of the setting to be influenced in a targeted manner.

The invention further relates to a machine learning model, in particular the machine learning system described above, which has been trained using at least one data set that has been obtained by a method according to the invention. The machine learning model according to the invention thus provides the same advantages as described in detail with regard to a method according to the invention.

Within the scope of the invention, it may be provided that the machine learning model according to the invention has been trained for use for at least semi-autonomous driving and/or for a driver assistance system. As a result, the vehicle can be controlled more precisely, even in complex driving scenarios, and the machine learning model may thus contribute to safety of the vehicle. In addition, the training on the data set that is generated by the method according to the invention allows a high level of accuracy in the recognition and interpretation of surroundings information, resulting in improved responsiveness to traffic conditions.

Broadly speaking, the machine learning system, in particular the machine learning model according to the invention, may be used in a vehicle. The vehicle may be designed as a motor vehicle and/or passenger car and/or autonomous vehicle, for example. The vehicle may have a vehicle device, for example for providing an autonomous driving function, and/or a driver assistance system. The vehicle device may be designed to at least semi-automatically control and/or to accelerate and/or brake and/or steer the vehicle, based on an output of the learning system.

The subject matter of the invention further relates to a computer program, in particular a computer program product, that includes commands which, when the computer program is executed by a computer, prompt the computer to carry out the method according to the invention. The computer program according to the invention thus provides the same advantages as described in detail with regard to a method according to the invention.

The subject matter of the invention further relates to a device for data processing that is configured to carry out the method according to the invention. For example, a computer that executes the computer program according to the invention may be provided as the device. The computer may have at least one processor for executing the computer program. In addition, a nonvolatile data memory may be provided in which the computer program is stored and from which the computer program may be read out by the processor for the execution.

The subject matter of the invention further relates to a computer-readable memory medium that includes the computer program according to the invention and/or commands which, when executed by a computer, prompt the computer to carry out the method according to the invention. The memory medium is designed, for example, as a data memory such as a hard disk and/or a nonvolatile memory and/or a memory card. The memory medium may be integrated into the computer, for example.

In addition, the method according to the invention may also be carried out as a computer-implemented method. Alternatively or additionally, at least one of the disclosed method steps may be computer-implemented and/or carried out in an automated manner.

### BRIEF DESCRIPTION OF THE DRAWINGS

Further advantages, features, and particulars of the invention result from the following description, in which exemplary embodiments of the invention are described in detail with reference to the drawings. The features mentioned in the claims and in the description, in each case alone or in any given combination, may be essential to the invention. In the figures:

FIG. 1 shows a schematic visualization of a method, a device, a memory medium, and a computer program according to exemplary embodiments of the invention.

FIG. 2 shows by way of example problems in conditioning the stable diffusion on Canny edges, using only ControlNet.

FIG. 3 shows an approach that is proposed according to exemplary embodiments, with combined masked conditions for the training of ControlNet.

### DETAILED DESCRIPTION

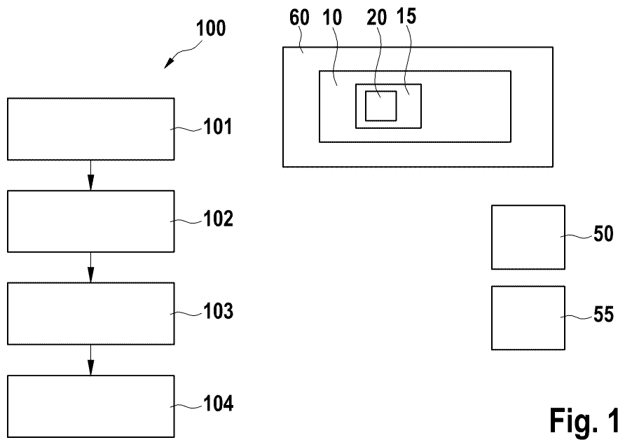

A method 100, a device 10, a memory medium 15, a vehicle 60, a control model 50, a learning system 55, and a computer program 20 according to exemplary embodiments of the invention are schematically illustrated in FIG. 1.

The method 100 may be used to generate at least one data set for training and/or testing a machine learning system 55. The generation of the at least one data set may be provided by a control model 50.

According to a first method step 101, a selection of at least two different conditions for an application for the generation of the data set is possible. The conditions may in each case provide different control options for the generation of the data set, wherein an influence of the particular condition on the generation is specified.

According to a second method step 102, a selection of areas 307 takes place within the conditions in which the application of the conditions is excluded.

In a third method step 103 the selected conditions are combined.

According to a fourth method step 104, generation of the data set may then be provided, using the control model 50 with application of the combined conditions and with consideration of the selected areas 307.

The method 100 may also include provision of original images 301 that are provided for training the control model 50 and/or an image diffusion model that are/is controlled by the control model 50. The selection 102 of the areas 307 in the form of pixels and/or points and/or two-dimensional areas in the original image 301 may then be carried out, in which the in particular combined conditions are not to be provided. In other words, areas that are to be free of influence from the conditions are masked. In these areas, no control with regard to the conditions takes place via the control model 50.

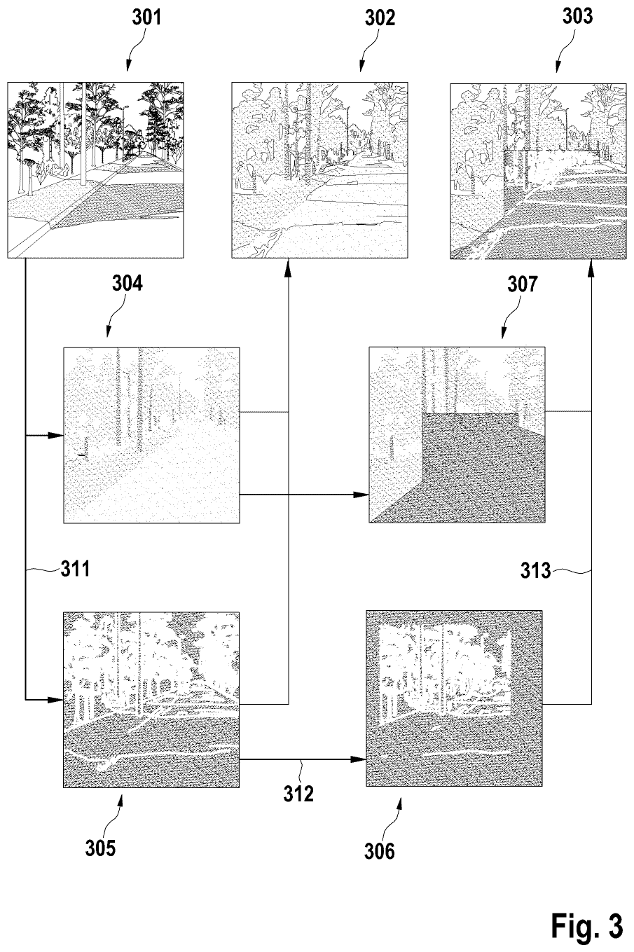

The original images 301 illustrated by way of example in FIG. 3 may represent a traffic scenario in order to use the data set for training and/or testing the machine learning system 55, for example for controlling a vehicle 60 for at least semi-autonomous driving and/or for a driver assistance system.

The control model 50 may be designed as ControlNet, for example. ControlNet (see [1] in the references listed at the end of the description section) is an expansion of the Stable Diffusion model, and allows refined adaptations using a plurality of conditions. The conditions may include semantic segmentation label maps, Canny edges, pose estimates, and/or additional parameters. These conditions facilitate the regulation of the image generation process during the inference phase. This may result in data that adhere to certain setting layouts, and at the same time maintain the robust text conditioning of the pretrained Stable Diffusion model.

Despite the great potential of this technology, there are certain limitations. When Canny edges, which are extracted from a separate image for the conditioning, are used, certain objects may not provide enough information to correctly identify the edges as “pedestrians.” This involves, for example, objects that are situated far away in a setting, such as a pedestrian at the other end of a street. Consequently, the diffusion process could perceive this portion of the input as an interference signal, and could generate an inappropriate object. In addition, problems have been identified in the conditioning of the stable diffusion using semantic label maps (SLMs). For example, if an SLM or Canny edges is/are extracted from a master image, in the generated images this may often result in an unexpected orientation and scaling of the marked object, such as an automobile.

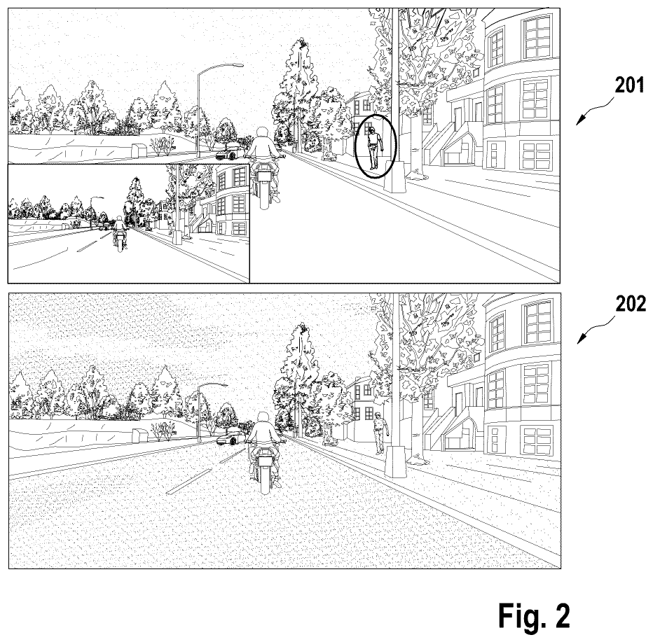

FIG. 2 shows by way of example problems in conditioning the stable diffusion on Canny edges, using only ControlNet. The original image 201 from which the edges are extracted is shown. The generated image 202 is illustrated underneath. When the edges are noisy and not recognized by the model, objects may disappear, such as the marked pedestrian in the example.

However, this problem may be reduced by adding class information for the pedestrian. Thus, according to exemplary embodiments of the invention it is proposed to carry out the implementation of multiple simultaneous conditions, to which different weights (masks) are assigned in each case during the training phase. The information supplied to the diffusion model may be enhanced in this way. This expanded information may be utilized during the inference to at least partially eliminate the above-stated problem.

Due to the simultaneous use of conditions such as Canny edges and semantic label maps, the semantic label map, even in situations in which the edges cannot identify the remote pedestrian, can supply the necessary information and thus ensure an accurate representation of the pedestrian in the image generation. This approach therefore offers numerous advantages over the existing prior art.

In embodiment variants of the invention, methods that are known per se from [1], [2], or [3], for example, may additionally be used. In particular, text-to-image diffusion models such as Stable Diffusion have been combined with external control signals such as Canny edge, semantic label maps, sketches, etc. This allows granular control over the image generation process which goes beyond strictly prompts. A high level of control over various aspects of the image is provided by means of such conditioning. For example, properties such as position, orientation, and pose of objects may be defined using Canny edge. These are conditions that cannot be defined using prompts alone. A high level of control over text-to-image models such as Stable Diffusion may thus be provided.

The decision concerning which conditional control is to be used has both advantages and disadvantages, and should be made on the application decision level. When the Canny edge is used, for example pose and orientation may be defined, but for objects that are far in the background or for a large number of objects situated close to one another, the Canny edge may possibly not supply the diffusion model with the correct information concerning which object on the image is to be marked. This may preferably be solved by using semantic label maps as conditions which, for each pixel in the image, define which object class is to be marked. However, this does not give the user control over the object position and orientation, as would be the case with Canny edge.

Exemplary embodiments of the invention thus provide an approach for combining the advantages of multiple conditioning inputs, and at the same time, mitigating their limitations.

| Condition | Canny edge | Semantic label map |
|---|---|---|
| Advantages | Control: Fine-grained control | Versatility: Ensures that the desired |
| | over object features such as | object/the desired class is found for |
| | pose and orientation. | each pixel in the image. Gives the |
| | | diffusion model more “freedom” |
| | | (versatility) in how it is to mark the |
| | | desired object. |
| Disadvantages | Objects that are small (or far in | Little control over various features |
| | the background) may be | of the desired object such as pose, |
| | overlooked. | orientation, shape, or the like. |

One option for combining multiple conditions is to use multiple ControlNets that are linked to the same Stable Diffusion backbone, also referred to as “multi-ControlNet.” A ControlNet functions by adding or subtracting the node outputs of the Stable Diffusion model on various intermediate layers in order to steer the model in the direction of the control input. When they are trained, only the ControlNet models are updated, so that they effectively learn how the diffusion model is controlled, and not how an image is directly generated.

Since ControlNet models add and subtract only the values of the diffusion model at each point, any number of ControlNet models may be stacked via the diffusion model, and for each step, each will steer in its own direction, leading to a cumulative effect of “obeys all controls” for the end result.

In practice, however, this strategy has not proven successful in generating high-quality images, since multiple interlinked conditions may interfere with one another (since they have not been jointly trained), and it is not possible to apply different conditions to different image areas. As an example, a driving scenario may be used in which the automobiles are defined by Canny edges, and the background is defined by a semantic label map. This configuration would allow precise control over the appearance of the automobiles, and at the same time would give the model creative freedom in the design of the background, so that the user can set a balance between control and diversity in various image regions. This critical aspect is examined in greater detail below. As a starting point, reference is made to:
[1] Zhang, Lvmin, and Maneesh Agrawala. “Adding conditional control to text-to-image diffusion models.” arXiv preprint arXiv:2302.05543 (2023).
[2] Mou, Chong, et al. “T2i-adapter: Learning adapters to dig out more controllable ability for text-to-image diffusion models.” arXiv preprint arXiv:2302.08453 (2023).
[3] Huang, Lianghua, et al. “Composer: Creative and controllable image synthesis with composable conditions.” arXiv preprint arXiv:2302.09778 (2023).

Exemplary embodiments of the invention propose a new variation of a training of an individual ControlNet, which simultaneously incorporates multiple conditions. To avoid the problem described above, it is important to train these conditions together. In addition, each condition during the inference should be optional, so that the diffusion process can generate high-quality images using a subset of conditions, and can take into account conditions that are present only in certain spatial regions. This flexibility allows precise detailing of the setting where it is necessary (object inpainting, for example), while at the same time, unconstrained regions for a larger variance are maintained.

FIG. 3 shows an approach that is proposed according to exemplary embodiments, with combined masked conditions for the training of ControlNet. In the resulting condition tensor 203 (top right), some areas contain only markings, other areas contain only canny edges, and some areas contain both or none of these.

Conditions are initially extracted from the original image 301 (see 311). This results in semantic labels 304 and Canny edges 305, which may be used as conditions 302 for the generative image synthesis. The results 306, 307 may be obtained from a masking 312, and may be combined to form conditions (see 313 and 303).

In principle, for each type of condition (Canny, semantic label, color palette, depth map, etc.) there may be at least three or exactly three possible actions: full retention, partial retention (according to classes or areas), or removal. By determining an optimal combination of these options for various condition maps during the training, in the inference phase high-quality images may be generated from each combination of conditions.

It is thus possible to combine multiple conditions for controlling the image generation of diffusion models. These may be masked and thus applied to the entire image or only to subareas, which allows greater flexibility in the image generation. Although multiple conditions are applied in the training period, it is not mandatory to use multiple conditions in the inference period, and the decision may always be made for a single condition.

Since multiple conditions are trained together, higher image quality may be ensured when multiple conditions are used in the inference period. The disjoint training of multiple conditions (of the current prior art) results in an inconsistent image generation process in which the multiple conditions cannot be easily combined.

Therefore, one objective according to embodiment variants of the invention is the generation of photorealistic images using predefined driving scenarios, with the conditions for the synthetic image generation being extracted from existing actual images or simulated images by means of diffusion models.

As one possible application of the method according to embodiment variants of the invention, it is conceivable to use these synthetic images for enhancing (expanding) the training and the validation of autonomous driving systems. However, in principle the proposed approach is not limited to this application, and may be used in any scenario in which synthetic images are desired.

In the above explanation of the embodiments, the present invention is described solely in terms of examples. Of course, individual features of the embodiments, if technically feasible, may be freely combined with one another without departing from the scope of the present invention.

1. A method for generating at least one data set for training and/or testing a machine learning system, the generation being provided by a control model, comprising:
selecting at least two different conditions for an application for the generation of the data set, which in each case provide different control options for the generation of the data set, and an influence of the particular condition on the generation being specified,
selecting areas within the conditions in which the application of the conditions is excluded,
combining the selected conditions,
generating the data set by means of the control model for application of the combined conditions, and with consideration of the selected areas.

2. The method according to claim 1,
characterized in that
during generation of the data set, control of the generation process is carried out by the control model corresponding to the selected conditions and limited to the nonexcluded area, and
areas are also selected in which the application of the conditions is completely excluded, and in which no influence of the conditions is thus specified, and/or conditions are applied and therefore the generation, with respect to the conditions, takes place uncontrolled by use of the control model

3. The method according to claim 1,
characterized in that
the method further comprises:
detecting a first user input that specifies a manual selection of the conditions,
detecting a second user input that specifies a manual selection of the areas,
wherein the selection of the conditions takes place based on the first user input, and the selection of the areas takes place based on the second user input, to allow the user to decide which conditions are to be combined, and to allow the user to mask those conditions that control their influence on the generation of the data set.

4. The method according to claim 1,
characterized in that
the machine learning system is designed as a model for image synthesis, and/or
the control model is designed as a model for controlling an image diffusion model for image synthesis, and
the data set includes multiple synthetic images that represent objects in an environment, which are provided for training and/or testing the machine learning system,
wherein a configuration and/or arrangement of the objects are/is influenced by the application of the conditions.

5. The method according to claim 1,
characterized in that
the application of the combined conditions is provided by a single control model.

6. The method according to claim 1,
characterized in that
the method further comprises:
providing original images that are provided for training the control model and/or an image diffusion model that is controlled by the control model,
carrying out the selection of the areas in the form of pixels and/or points and/or two-dimensional areas in the original image.

7. The method according to claim 6,
characterized in that
the original images represent a traffic scenario in order to use the data set for training and/or testing the machine learning system for controlling a vehicle for at least semi-autonomous driving and/or for a driver assistance system.

8. The method according to claim 1,
characterized in that
the training is provided for training the machine learning system based on the generated data set for classification of digital images based on image points and/or pixels.

9. The method according to claim 1,
characterized in that
via the selection of the conditions and areas, an influence of the conditions may be dynamically retained, partially retained, and/or removed during a generation process for the data set.

10. The method according to claim 1,
characterized in that
conditions include at least two of the following elements:
canny edges for edge and structure recognition,
semantic labels for classification and annotation of objects,
a color palette for visual differentiation and classification,
depth maps for capturing and analyzing spatial information.

11. The method according to claim 1 further comprising training a machine learning model with the data set.

12. The method according to claim 11,
characterized in that
the machine learning model has been trained for use for at least semi-autonomous driving and/or for a driver assistance system.

13. (canceled)

14. A device for data processing comprising:
a processor; and
a non-transitory computer-readable memory medium storing a computer program that when executed by the processor, causes the processor to:
select at least two different conditions for an application for the generation of the data set, which in each case provide different control options for the generation of the data set, and an influence of the particular condition on the generation being specified,
select areas within the conditions in which the application of the conditions is excluded,
combine the selected conditions, and
generate the data set by means of the control model for application of the combined conditions, and with consideration of the selected areas.

15. A non-transitory computer-readable memory medium storing a computer program which, when executed by a processor, cause the processor to:
select at least two different conditions for an application for the generation of the data set, which in each case provide different control options for the generation of the data set, and an influence of the particular condition on the generation being specified,
select areas within the conditions in which the application of the conditions is excluded,
combine the selected conditions, and
generate the data set by means of the control model for application of the combined conditions, and with consideration of the selected areas.

16. The method of claim 3, wherein the generation of the data set comprises image synthesis.

17. The method of claim 4, wherein the model for image synthesis is an image diffusion model.

18. The method of claim 5, wherein generation of the data set takes place by use of only the single control model, and wherein the single control model comprises an end-to-end trained ControlNet.

19. The method of claim 6 wherein at least one of.
(a) the combined conditions are not to be provided;
(b) the conditions are designed as spatially defined;
(c) the conditions are designed as at least two-dimensional; and/or
(d) the conditions are designed in the form of a mask or map.

20. The method of claim 8 wherein the digital images result from a recording of surroundings of a vehicle during travel and/or by a camera, wherein control of the vehicle is provided based on the classification.
